(19) United States
(12) Patent Application Publication
(10) Pub. No.: US 2005/0012333 A1
(43) Pub. Date: Jan. 20, 2005

(54) Pipe connecting method and apparatus

(75) Inventors: James Baich, LaPorte, IN (US); Shuqing Cui, Valparaiso, IN (US); Dan Losinski, LaPorte, IN (US); Neil Rolph, LaPorte, IN (US)

Correspondence Address: BAKER & HOSTETLER LLP;Washington Square, Suite 1100, 1050 Connecticut Avenue, N.W., WASHINGTON, DC, 20036, US

(73) Assignee: United Dominion Industries, Inc.

(21) Appl. No.: 10/617,702

(22) Filed: Jul. 14, 2003

(51) Int. Cl. F16L 17/00

(52) U.S. Cl. 285/354

(57) ABSTRACT

A method and apparatus for connecting two pipe ends is provided. The apparatus includes a housing, a first chamber contained within the housing and configured to allow a pipe to slide through it, a second chamber contained within the housing and configured to allow an end of a pipe to side through it, and a third chamber contained within the housing and configured to attach to an end of a second pipe. The method includes sliding a first pipe through a slip joint adapter, positioning the slip joint adapter to the desired location on the first pipe; and attaching the slip joint adapter to an end of a second pipe.

### FIELD OF THE INVENTION

The present invention relates generally to an adapter for connecting two pipes together. More particularly, the present invention relates to an adapter capable of varying in length for connecting two pipes together.

### BACKGROUND OF THE INVENTION

In a variety of appliances and apparatuses that use piping, there is frequently a need for two pipes to be joined together. In such instances an adapter or joiner is typically used to connect the pipe ends. Often the pipes are of a fixed dimension and the pipe ends placed at fixed points. In such instances, an adapter or joiner is used to connect the pipe ends. When the pipe ends are at fixed locations, the pipe ends can not move to adapt to the joiner, so the joiner must adapt to the pipe ends. When making a large number of two pipe connections, such as in a mass production setting, it would be desirable to use a single part as the same connector for all similar two pipe connections.

One challenge to using a single connector for a variety of possible connections, is that from connection to connection, buildup of manufacturing tolerances may cause the pipes to be not the right length with respect to each other in order to provide a connection using a given connector. One way to correct for the tolerance buildup or other factors causing the pipes to be located at different lengths with respect to each other is to hand fit each connection according to the different lengths of pipe. This is a labor intensive way to deal with the problems in pipe connecting.

In addition to merely connecting pipes of different lengths, often the pipe connections need to be sealed. For example, a pipe used to transport fluids may necessitate a sealed pipe connection so that the fluid, whether liquid or gas, will not leak at the point of connection.

Accordingly, it is desirable to provide a method and apparatus that is adaptable for connecting pipe ends having relatively fixed ends that may be located at varying lengths from each other. In addition, it is also desirable to provide a connector adaptable for connecting not only pipe ends spaced at different lengths from each other but also connecting the pipe ends in a sealed manner.

### SUMMARY OF THE INVENTION

The foregoing needs are met, to a great extent, by the present invention, wherein in one aspect an adaptor apparatus is provided that in some embodiments can be adjusted to connect pipe ends located at various lengths from each other. In further aspects of the invention, an adapter can connect and seal pipe ends located at various lengths from each other.

In accordance with one embodiment of the present invention, a slip joint adaptor is provided. The slip joint adaptor includes a housing, and a first chamber contained within the housing and configured to allow a pipe to slide through it. The slip joint adaptor further includes a second chamber contained within the housing and configured to allow an end of a pipe to side through it. The slip joint adaptor further includes a third chamber contained within the housing and configured to attach to an end of a second pipe. Optionally, the slip joint adapter may also have at least one annular grove in the first chamber configured to house an O ring gasket. Some embodiments of the invention may include a pipe extending through the first chamber in a slidable fashion and having an end in the second chamber, an O ring gasket in the at least one groove the O ring gasket having an inner diameter less than an outer diameter of the pipe, and the O ring gasket having an outer diameter greater than the diameter of the groove.

Optionally, the slip joint adapter can include a tapered portion located between the first and second chamber. Some slip joint adapters in accordance with the invention can include a pipe extending through the first chamber in a slidable fashion and terminating with a flared end in the second portion, the flared portion having a diameter sufficient to prevent the pipe end from sliding through the first chamber, and/or a shoulder having a diameter greater than a diameter associated with the first chamber, the shoulder mounted on a portion of the pipe located outside the housing and located on the pipe to but against the housing and prevent the end of the pipe from extending into the third chamber. The adapter may further include a pipe extending through the first chamber in a slidable fashion and having an end in the second chamber; and a seal located between the pipe and the housing substantially sealing the second chamber from the outside of the housing via the first housing.

In accordance with another embodiment of the present invention, A slip joint adapter is provided. The slip joint adapter includes means for housing a pipe configured to allow an end of a first pipe to slide through it, means for limiting sliding motion of the first pipe so that the first pipe does not slide out of the housing means, and means for attaching to an end of a second pipe. Optionally, the slip joint adapter may further include the attaching means having a substantially hexagonal outer cross-section and/or attaching means having threads for attaching to an end of a second pipe. Some slip joint adapters in accordance with the invention can include at least some of the following: at least one seal containing means in the means for housing; a pipe extending through the housing means in a slidable fashion and terminating with a flared end configured to prevent the flared end from sliding out of the housing means, a pipe extending through the housing means; a stop located on the pipe and located on the pipe to prevent the end of the pipe from extending into the housing means farther than a predetermined distance, a pipe extending through the housing means; and means for sealing the pipe into the housing means.

In accordance with yet another embodiment of the present invention, a method of attaching two pipe ends is provided. The method includes: sliding a first pipe through a slip joint adapter, positioning the slip joint adapter to the desired location on the first pipe, providing a stop on the first pipe that blocks the first pipe from sliding into the slip joint adapter farther than a predetermined distance, and attaching the slip joint adapter to an end of a second pipe. Optionally, the method may include sealing the first pipe with the slip joint adapter, and flaring the end of the first pipe, providing a shoulder on the first pipe.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view illustrating a slip joint according to a preferred embodiment of the invention.

FIG. 2 is a side view of the slip joint adapter of FIG. 1.

FIG. 3 is a perspective view of a boiler with a cover removed so that the interior of the boiler may be seen illustrating one use of an embodiment of the present invention.

FIG. 4 is a perspective view of a slip joint according to another embodiment of the invention.

### DETAILED DESCRIPTION

The preferred embodiments of the invention will now be described with reference to the drawing figures, in which like reference numerals refer to like parts throughout. An embodiment in accordance with the present invention provides a slip joint adapter which is adaptable to extend or contract to various lengths and connect two pipes, whose ends are fixed in relation to each other, to be connected to each other. In some embodiments the slip joint adapter includes a housing, a first chamber contained within the housing and configured to allow pipe to slip through it, a second chamber which allows the pipe end to move through it, and a third chamber configured to attach to end of a second pipe.

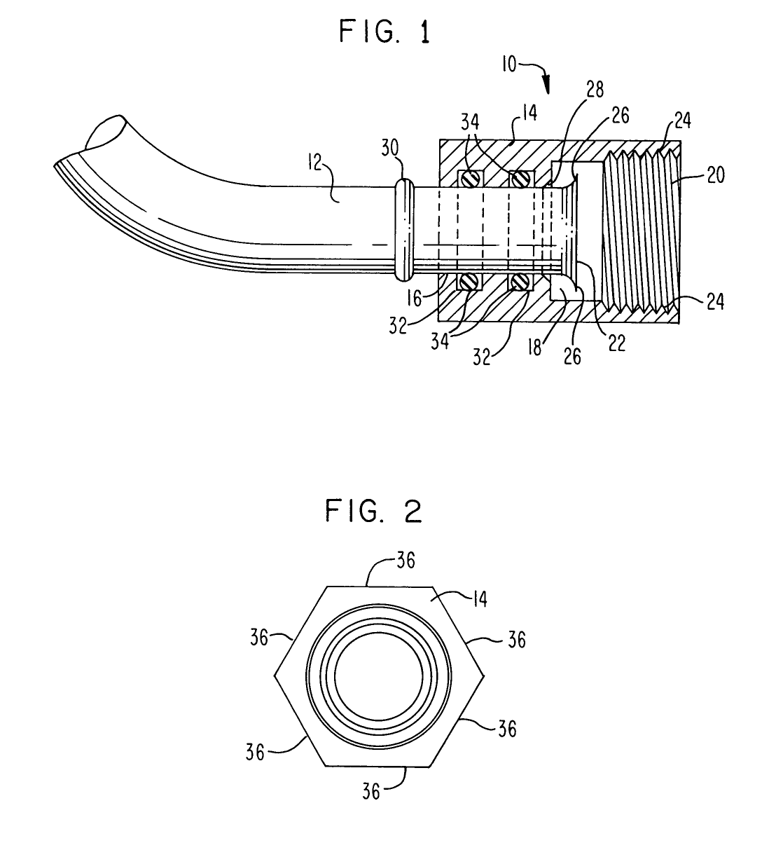

An embodiment of the present inventive apparatus is illustrated in FIG. 1. FIG. 1 shows a slip joint adapter 10 connected to a pipe 12. The slip joint adapter 10 has a housing 14 with three chambers 16, 18 and 20. Chamber 16 is configured for a pipe 12 to slide through it. Chamber 18 has a larger diameter than the sliding chamber 16 and is configured to allow the pipe's end 22 to slide in chamber 18.

The feature of allowing the pipe 12 to slide axially through the adapter 10 allows the slip joint adapter 10 to adapt to connecting two pipes together when the distance between the pipe ends can vary from application to application.

The slip joint adapter 10 has another chamber 20 also known as the attaching chamber 20. The attaching chamber 20 is configured to attach to a second pipe end. In the embodiment shown in FIG. 1 the attaching chamber 20 is equipped with threads 24 for attaching to a second pipe end.

In other embodiments the invention, other attaching means may be used rather than threads. For example, the slip joint adapter 10 may attach by a welding. A chemical weld may be used if the slip joint adapter 10 and the second pipe are made of PVC. The attaching chamber 20 may also attach to a second pipe in a variety of the means well known to those skilled in the art. Thus, the threads 24 as shown in FIG. 1 are meant to be exemplary only and not limiting.

The pipe end 22 is flared 26 and the flared end 26 helps reduce the likelihood that the pipe 12 will slip all the way out of the adapter 10. If the pipe 12 were to be slid too far out of the adapter 10, the flared end 26 would contact an interior portion of the adapter 10 and prevent the pipe 12 from slipping completely out of the adapter 10.

In some embodiments of the invention, the adapter 10 is also equipped with a tapered section 28. The tapered section 28 is configured to allow the flared end 26 to fit flush within the tapered section 28.

According to some embodiments of the invention, as shown in FIG. 1, the pipe 12 is also equipped with a shoulder 30. The shoulder 30 is mounted on the pipe 12 and is configured to prevent the pipe 12 from being inserted into the adapter 10 more than a desired distance. As the pipe 12 is slid into the adapter 10, at a certain point, the shoulder 30 will contact the housing 14 and prevent the pipe 12 from sliding any farther into the adapter. For example, it may be desired that the pipe 12 does not contact the other pipe to which the slip joint adapter 10 is attached to. One skilled in the art will know where to locate the shoulder 30 on the pipe 12 in order to prevent the pipe 12 from sliding into the slip joint adapter 10 and allowing the end 22 to contact the second pipe to which the slip joint adapter 10 is attached.

According to some embodiments of the present invention, as shown in FIG. 1, the connection between the pipe 12 and the slip joint adapter 10 can be sealed. Seal grooves 32 are provided in the slip joint adapter 10. Located within the seal grooves 32 are O ring gaskets 34. The O ring gaskets 34 are sized so that they provide an interference fit both with the pipe 12 and the slip joint adapter 10.

It may be desired to flow various fluids through the pipe 12 such as oil, natural gas or propane. Regardless of whatever fluid is flowed through the pipe, the pipe 12 and slip joint adapter 10 can be attached to each other in a sealed manner by gaskets. The O rings 34 shown in FIG. 1 are meant to be exemplary only and not limiting to the type of sealed arrangements that can attach pipe 12 with the slip joint adapter 10. One skilled in the art, after reviewing this disclosure, will able to incorporate other type of sealing arraignments that will fall within the scope of the present invention.

The operation of an embodiment of the invention is as follows. The adapter 10 is slid over the pipe end 22. Chamber 16 is first to engage the pipe end 22. The adapter 10 is slid onto the pipe 12 until the pipe end 22 is within chamber 18. Optionally, the pipe end 22 will then be flared. One way to flair the pipe end 22 is to insert a flaring tool through chamber 20. The flaring is accomplished by any suitable means well known in the art.

The adapter 10 is then slid along pipe 12 to position the adapter 10 to engage a second pipe end via chamber 20. In instances where the adapter 10 engages the second pipe end via threads 24, the adapter 10 is turned to cause the adapter 10 and second pipe end to attach via the threads 24. The threads 24 can be coated or sealed to create a sealed connection between the adapter 10 and the second pipe by any suitable means well known in the art. As previously mentioned, connecting the adapter 10 with a second pipe end with threads 24 is exemplary only, other means for connecting well known in the art may also be used.

FIG. 2 is a cross sectional view of the slip joint adapter 10 shown in FIG. 1. The outer shape of the housing 10 is shaped as a hexagon and has several flats 36. The flats 36 are useful in allowing a wrench to engage the housing 14 of the slip joint adapter 10. The slip joint adapter 10 can be turned by a wrench to attach the adapter 10 to a second pip with the threads 24.

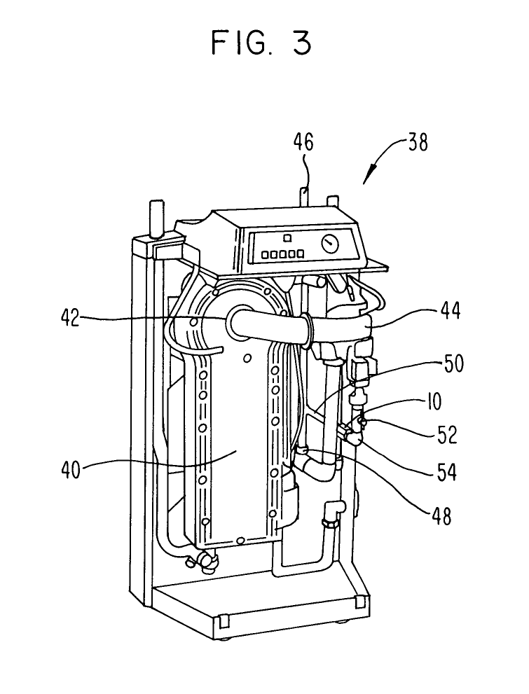

According to some embodiments of the present invention, as shown in FIG.3, the slip joint adapter 10 can be used in a boiler 38. The boiler 38 shown in FIG. 3 is exemplary of an application in which an embodiment of the present invention may be used. The covering of the boiler 38 has been removed in order to allow better view of the slip joint adapter 10 mounted within the boiler 38.

The boiler 38 is equipped with a heat exchanger 40. The heat exchanger 40 has a combustion chamber 42 located at the top end in which fuel and air are burned providing the heat to be exchanged in the heat exchanger 40. The air and fuel mixture enter into the combustion chamber 42 by a blower 44. The fuel enters the boiler 38 by a fuel inlet pipe 46. The fuel inlet pipe is capped on one end with a cap 48. A section pipe 50 branches off from the fuel inlet pipe 46. A gas valve 52 is attached to an elbow 54. Due to the nature of the construction of the boiler 38, the branch section of pipe 50, the fuel inlet pipe 46, and the gas valve 52 are located at a fixed location within the boiler 38 and are not easily adjusted. In addition, during the manufacturing process, the tolerances permitted within the manufacturing of the boiler 38 may build up causing the end of the section of 50 of the fuel inlet pipe 46 and the elbow 54 may vary in location from boiler to boiler.

In order to provide a single connector useful for connecting the branch 50 of the pipe 46 and the elbow 54 when the pipe end locations vary from boiler to boiler, the adjustable slip joint adapter 10 is used. The slip joint adapter 10 connects the branch 50 of the inlet pipe 46 to the elbow 54 and is adaptable to vary in length according to the needs of an individual boiler 38.

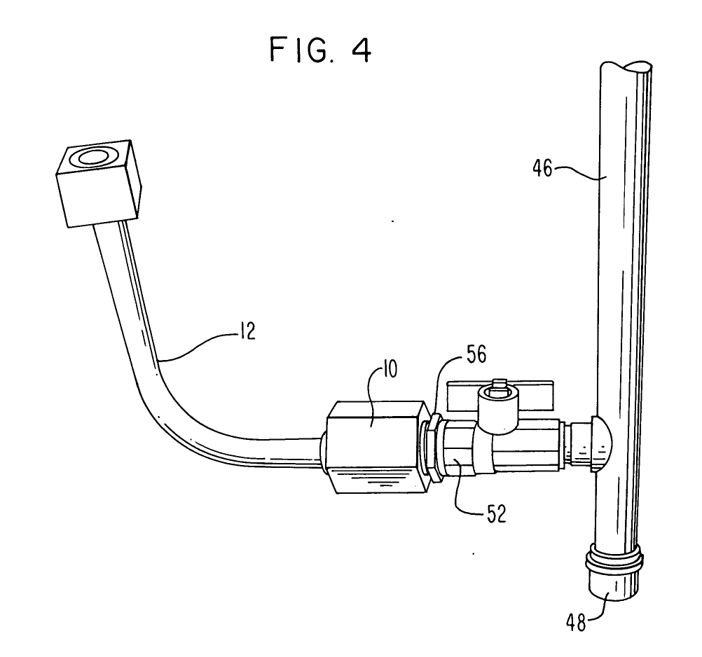

According to another embodiment of the present invention, the slip joint adapter 10 can be used other configurations as shown in FIG. 4. In FIG. 4 a gas supply tube 46 has a cap 48 on one end. Branching out from approximately a 90° angle from the gas supply tube 46 a gas valve 52 is mounted. The gas valve 52 is connected to the slip joint adapter 10 via transition piece 56. Although an example of the slip joint adapter 10 is shown in a boiler 38, it will be appreciated that the slip joint adapter 10 can be used in a variety of different applications. The slip joint adapter 10 can be used nearly anytime two pipe ends need to be connected.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents maybe resorted to, falling within the scope of the invention.

1. A slip joint adaptor comprising:
a housing having a substantially hexagonal outer cross-section:
a first chamber contained within the housing and configured to allow a pipe to slide through it;
a second chamber contained within the housing and configured to allow an end of a pipe to slide through it and to provide a bridge for material flowing from the pipe to a second pipe when an end of the pipe does not contact an end of the second pipe; and
a third chamber contained within the housing and configured to attach to an end of a second pipe.

2. The slip joint adaptor of claim 1, wherein the first, second and third chambers are substantially coaxial.

3. (Cancelled)

4. The slip joint adaptor of claim 1, wherein the third chamber has threads for attaching to an end of a second pipe.

5. The slip joint adaptor of claim 1, further comprising at least one annular grove in the first chamber configured to house an O ring gasket.

6. The slip joint adaptor of claim 5, further comprising:
a pipe extending through the first chamber in a slidable fashion and having an end in the second chamber; and
an O ring gasket in the at least one groove the O ring gasket having an inner diameter less than an outer diameter of the pipe, and the O ring gasket having an outer diameter greater than the diameter of the groove.

7. The slip joint adaptor of claim 1, further comprising a tapered portion located between the first and second chambers.

8. The slip joint adaptor of claim 1, further comprising a pipe extending through the first chamber in a slidable fashion and terminating with a flared end in the second portion, the flared portion having a diameter sufficient to prevent the pipe end from sliding through the first chamber.

9. The slip joint adaptor of claim 1, further comprising:
a pipe extending through the first chamber in a slidable fashion and having an end in the second chamber; and
a shoulder having a diameter greater than a diameter associated with the first chamber, the shoulder mounted on a portion of the pipe located outside the housing and located on the pipe to but against the housing and prevent the end of the pipe from extending into the third chamber.

10. The slip joint adaptor of claim 1, further comprising:
a pipe extending through the first chamber in a slidable fashion and having an end in the second chamber; and
a seal located between the pipe and the housing substantially sealing the second chamber from the outside of the housing via the first chamber.

11. A slip joint adaptor comprising:
means for housing a pipe configured to allow an end of a first pipe to slide through it the means for housing having a substantially hexagonal outer cross-section,
means for limiting sliding motion of the first pipe so that the first pipe does not slide out of the housing means; and
means for attaching to an end of a second pipe; and
means for bridging fluid flowing from the pipe to the second pipe when an end of the pipe does not contact an end of the second pipe.

12. The slip joint adaptor of claim 11, wherein the attaching means has a substantially hexagonal outer cross-section.

13. The slip joint adaptor of claim 11, attaching means has threads for attaching to an end of a second pipe.

14. The slip joint adaptor of claim 11, further comprising at least one seal containing means in the means for housing.

15. The slip joint adaptor of claim 11, further comprising a pipe extending through the housing means in a slidable fashion and terminating with a flared end configured to prevent the flared end from sliding out of the housing means.

16. The slip joint adaptor of claim 11, further comprising:
a pipe extending through the housing means; and
a stop located on the pipe and located on the pipe to prevent the end of the pipe from extending into the housing means farther than a predetermined distance.

17. The slip joint adaptor of claim 11, further comprising:
a pipe extending through the housing means; and
means for sealing the pipe into the means for housing.

18. A method of attaching two pipe ends comprising:
sliding a first pipe through a slip joint adapter;
positioning the slip joint adapter to the desired location on the first pipe;
providing a stop on the first pipe that blocks the first pipe from sliding into the slip joint adapter farther than a predetermined distance;
attaching the slip joint adapter to an end of a second pipe; and
bridging material carried by the pipe with the slip joint adapter between two non-contacting pipe ends.

19. The method of claim 18, further comprising sealing the first pipe with the slip joint adapter.

20. The method of claim 18, further comprising flaring the end of the first pipe.
